(19) United States
(12) Patent Application Publication
(10) Pub. No.: US 2022/0410619 A1
(43) Pub. Date: Dec. 29, 2022

(54) SPHERICAL OMNIDIRECTIONAL WHEEL

(71) Applicant: Joal Ollivier, Saskatoon (CA)

(72) Inventor: Joal Ollivier, Saskatoon (CA)

(21) Appl. No.: 17/777,540

(22) PCT Filed: Nov. 12, 2020
(86) PCT No.: PCT/CA2020/051539

§ 371 Date: May 17, 2022

Related U.S. Application Data
(60) Provisional application No. 62/939,822, filed on Nov. 25, 2019.

(51) Int. Cl. B60B 19/00; B60B 19/14; B60B 35/06

(52) U.S. Cl. CPC B60B 19/003; B60B 19/14; B60B 35/06; B60B 2200/20; B60B 2200/432; B60B 2380/12

(57) ABSTRACT

A wheel assembly comprising a shaft configured for rotatable connection to an object to be rendered mobile for rotation around a first axis, a hub rotatably connected to the shaft for rotation around a second axis, and two hemispherical members rotatably connected to the hub for rotation around a third axis. The shaft comprises at least one angled portion to define the first axis while the non-angled portion defines the second axis.

### TECHNICAL FIELD OF THE INVENTION

The present invention relates to wheels, and more particularly to wheels that are designed for enabling object movement in multiple directions.

### BACKGROUND OF THE INVENTION

The use of wheels is ubiquitous as a mechanism for imparting horizontal portability for objects such as furniture, office chairs, shopping carts, dollies, and the like.

Various wheel designs have been generated, with some gaining widespread usage and acceptance. For example, a typical caster wheel is shown in FIG. 1a. The caster wheel arrangement 1 comprises a wheel 2 rotating about a horizontal axis 3, the wheel 2 secured in place by means of a bracket 4 which itself rotates about a vertical axis 5, the bracket 4 rotatable with respect to a mounting plate 6 which is affixed to the object to be rendered mobile. However, the positions of the vertical axis 5 and the horizontal axis 3 results in a situation where the point where the wheel 2 contacts the floor or ground surface is horizontally offset from the vertical axis 5 in a direction opposite the direction of object travel when in motion, generating torque of variable orientation applied via mounting plate 6 to the object rendered mobile. Further, given this horizontal offset, a volume of space must be clear that is larger than the wheel 2 to allow the rotation of the bracket 4 with the wheel 2 around the vertical axis 5.

FIG. 1b illustrates another known prior art wheel mechanism, known as a ball caster. The ball caster arrangement 7 comprises a ball 8 held loosely within a retention housing 9, with the interfacing surfaces between the ball 8 and housing 9 designed for low friction, resulting in the ball 8 being able to rotate freely in all directions while being retained within housing 9. The retention housing 9 is secured to the object to be rendered mobile by means of a mounting plate 10. However, the ball 8 is composed of a very hard material such as steel which may be undesirable depending on the floor or ground surface, the ball 8 is sensitive to scratches which would increase friction, and the ball 8 may become coated with contaminants from the environment and foul the arrangement 7.

FIG. 1c illustrates another known prior art wheel mechanism, known as an omni wheel. The omni wheel arrangement 11 comprises a series of wheels or rollers 12 arranged circumferentially around the outer edge of a hub 13, the hub rotatable when mounted on a shaft passed through an aperture 14. Similarly, FIG. 1d illustrates another known prior art wheel mechanism, namely a Mecanum wheel. The Mecanum wheel arrangement 15 comprises a series of wheels 16 arranged around the outer edge of a hub 17 but in an angled orientation, the hub 17 configured for rotation by means of an aperture 18 for receiving a shaft. Both designs allow movement transverse to the respective shaft by rotation about the shaft, and movement parallel to the shaft by way of the rollers 12 and 16. However, the relatively small rollers may negatively impact utility on uneven ground surfaces as they cannot roll over obstacles as effectively in the direction parallel to the shaft.

FIG. 1e illustrates another known prior art wheel mechanism, arrangement 19, comprising a spherical wheel 21 supported by omni-wheels 20. However, as can be seen, this design is not only relatively complex but occupies a significantly greater volume compared to other designs; the same can be said of any design comprising a sphere supported by its outer surface, like the ball caster 7.

A spherical wheel would present an ideal solution to some of the above problems with prior art designs, but the connection member between the sphere centre and the object being moved would have to pass through the sphere surface without impacting rotation, which is not possible. FIG. 1f illustrates another known prior art wheel mechanism where a modification of the spherical wheel concept is shown, known as an omni ball, in which two hemispheres are used instead of a full sphere. The omni ball arrangement 22 comprises two hemispherical members 23 rotatably connected to a shaft 24, said shaft rotatably connected to an object to be rendered mobile. The rotatability provided by the shaft 24 would allow the hemispherical members 23 to roll allowing movement in a direction perpendicular to the shaft 24's axis, and, provided the axis of the members 23's rotatable connection to the shaft 24 is not vertical, the rotatable connection of the hemispheres 23 to the shaft 24 would allow movement in a direction parallel to the shaft 24's axis. The net result is the “sphere” having two rotational degrees of freedom, the axes of which pass through the sphere's center; this allows it to roll in two orthogonal directions. However, these degrees of freedom are not mutually exclusive: the members 23's axis is secondary to the shaft 24's axis. As the axis of the members 23's rotatable connection approaches vertical, movement in the direction parallel to the shaft 24 necessitates increasing rotational speed of the members 23. The relationship is asymptotic: the required rotational speed approaches infinity as the axis approaches the vertical position (perpendicular to the floor or ground surface). This greatly reduces the wheel's functionality: at positions within every half-revolution of the shaft 24's axis, the wheel cannot move in the direction parallel to the shaft 24's axis. To alleviate this limitation, a small roller 25 could be located in the center of the outer surface of each member 23, as shown in FIG. 1f, but roller 25 may not be able to effectively roll over irregularities in terrain due to its relatively small size, increases complexity, and could become fouled by surface contaminants.

### SUMMARY OF THE INVENTION

According to a first broad aspect of the present invention, there is provided a wheel assembly comprising a shaft configured for rotatable connection to an object to be rendered mobile for rotation around a first axis, a hub rotatably connected to the shaft for rotation around a second axis, and two hemispherical members rotatably connected to the hub for rotation around a third axis. The shaft comprises at least one angled portion to define the second axis while the non-angled portion defines the first axis.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1a is side perspective view of a conventional caster wheel arrangement;

FIG. 1b is a bottom perspective view of a conventional ball caster arrangement;

FIG. 1c is a side perspective view of a conventional omni wheel arrangement;

FIG. 1d is a side perspective view of a conventional Mecanum wheel arrangement;

FIG. 1e is side perspective, top plan, and side elevation views of a conventional omni ball arrangement;

FIG. 1f is top plan, and side elevation views of a conventional spherical wheel with supporting omni-wheels arrangement;

FIG. 1g is top plan, side perspective and side elevation views of a modified omni ball arrangement;

FIG. 2a is a top plan view of a first embodiment of an omni-directional wheel according to the present invention;

FIG. 2b is a side elevation view of the first embodiment of an omni-directional wheel according to the present invention;

FIG. 2c is a side perspective view of the first embodiment of an omni-directional wheel according to the present invention;

FIG. 3 is a sectional view along line A-A of FIG. 2a of the first embodiment of an omni-directional wheel according to the present invention;

FIG. 4a is a top plan view of a second embodiment of an omni-directional wheel according to the present invention;

FIG. 4b is a side elevation view of the second embodiment of an omni-directional wheel according to the present invention;

FIG. 4c is a side perspective view of the second embodiment of an omni-directional wheel according to the present invention;

FIG. 5 is a sectional view along line B-B of FIG. 4a of the second embodiment of an omni-directional wheel according to the present invention;

FIG. 6 is an exploded perspective view of the second embodiment of an omni-directional wheel according to the present invention;

FIG. 7a is a top plan view of a third embodiment of an omni-directional wheel according to the present invention;

FIG. 7b is a side elevation view of the third embodiment of an omni-directional wheel according to the present invention;

FIG. 7c is a side perspective view of the third embodiment of an omni-directional wheel according to the present invention;

FIG. 8 is a sectional view along line C-C of FIG. 7a of the third embodiment of an omni-directional wheel according to the present invention; and

FIG. 9 is an exploded perspective view of the third embodiment of an omni-directional wheel according to the present invention.

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to an omni-directional wheel assembly configured for rotatable connection to an object to be moved horizontally across a surface.

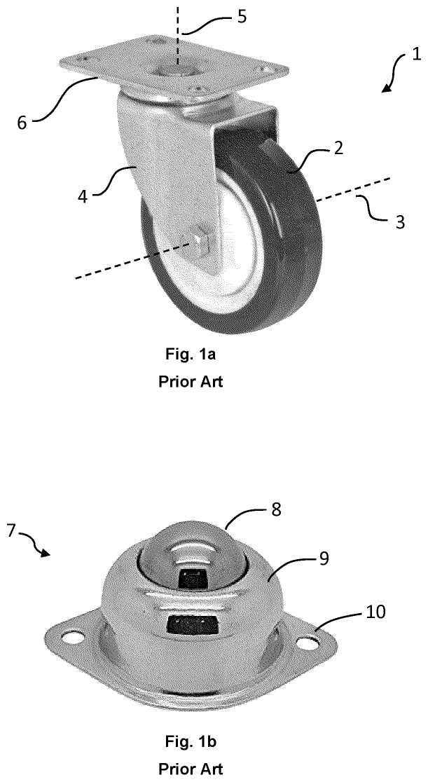

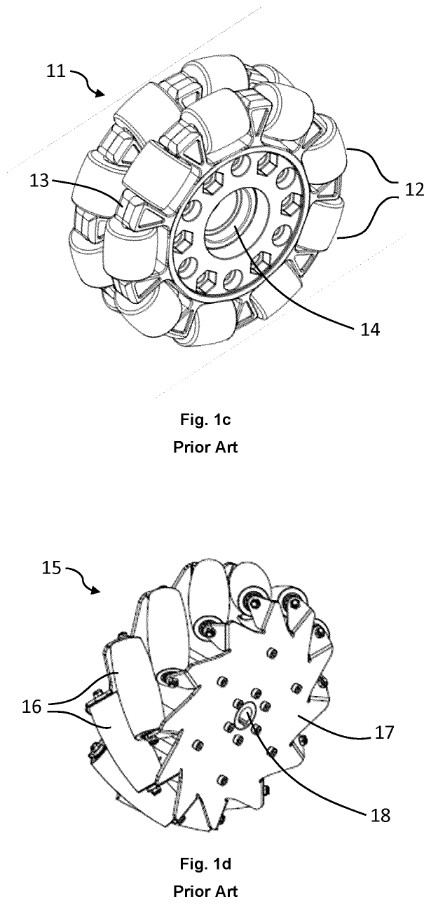

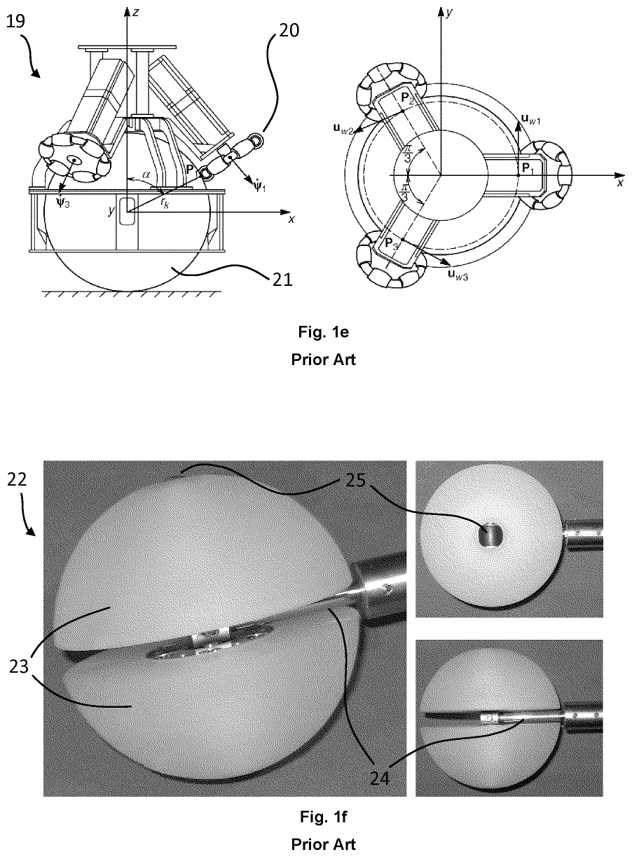

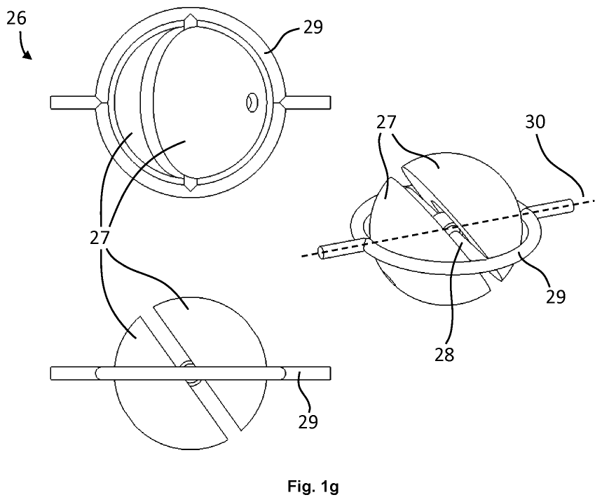

FIG. 1g illustrates a conceptual modification of the omni ball arrangement 22 of FIG. 1f, being arrangement 26 wherein two hemispherical members 27 are rotatably connected to shaft 28, but the shaft 28 itself is part of frame 29 which is rotatably connected along axis 30 to the object to be rendered mobile. Frame 29 adds a third degree of rotational freedom, and thus improves upon the omni ball arrangement by allowing the shaft 28 itself to rotate about axis 30, eliminating the need for the small roller 25. However, this encircling frame 29 precludes complete rolling along axis 30, and there remains positions of the axes which preclude movement in the direction parallel to axis 30.

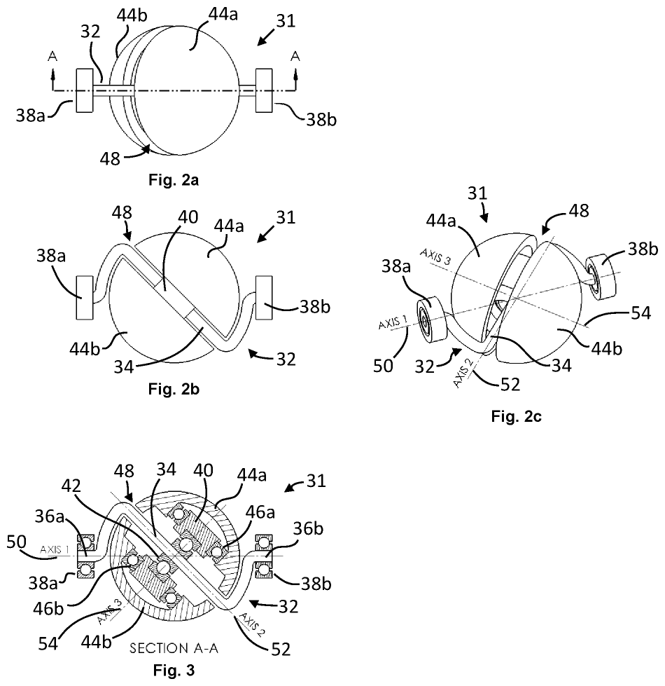

Turning now to FIGS. 2a to 3, a first embodiment of a wheel assembly 31 according to the present invention is illustrated. The wheel assembly 31 comprises a shaft 32, which in the illustrated embodiment consists of a central portion 34 and two end portions 36a,b, the latter specifically the end stubs of the shaft 32 that are configured to be received in bearings 38a,b. As can best be seen in FIG. 3, this angling of the shaft 32 results in the end portions 36a,b defining a first axis 50 while the central portion 34 defines a second axis 52. The end portions 36a,b are provided with the bearings 38a,b for rotatable connection to the object (not shown).

The wheel assembly 31 further comprises a hub 40 which is rotatably connected to the central portion 34 of the shaft 32 for rotation relative to the shaft 32 around the second axis 52. The hub 40 is connected to the central portion 34 by means of a bearing 42.

The wheel assembly 31 further comprises two hemispherical members 44a,b, which provide the outer surface to be in contact the floor or ground in operation. The hemispherical members 44a,b are rotatably connected to the hub 40 by means of bearings 46a,b such that the hemispherical members 44a,b can rotate relative to the hub 40 around a third axis 54 as shown in FIG. 3, and are spaced apart to form a gap 48 through which the shaft 32 passes.

As can be seen, then, there are three axes of rotation in the first exemplary embodiment. The shaft 32 rotates relative to the object being mobilized around the first axis 50, the hub 40 rotates relative to the shaft 32 around the second axis 52, and the hemispherical members 44a,b rotate relative to the hub 40 around the third axis 54. This assembly with three axes creates the desired omni-directional movement ability. The angle between the first 50 and second 52 axes all but eliminates the chance that the components can be positioned in such a way as to prevent the wheel assembly 31's movement in any direction, while also enabling unhindered rotation of axis 50, which is not possible with axis 30 in arrangement 26 illustrated in FIG. 1g due to the frame 29. Movement parallel to axis 50 may be locked when the wheel assembly 31 is in a position where all three axes lie on a common plane perpendicular to the floor or ground surface, however, this exact position is unlikely to occur and is only meta-stable as any slight disturbance or force acting perpendicular to the first axis 50 will break the alignment and allow movement. Additionally, as observed experimentally, the wheel assembly 31 tends to avoid said position as long as motion in the direction parallel to the first axis is not reversed: the axes tend to settle into a non-locking position for a given direction of travel.

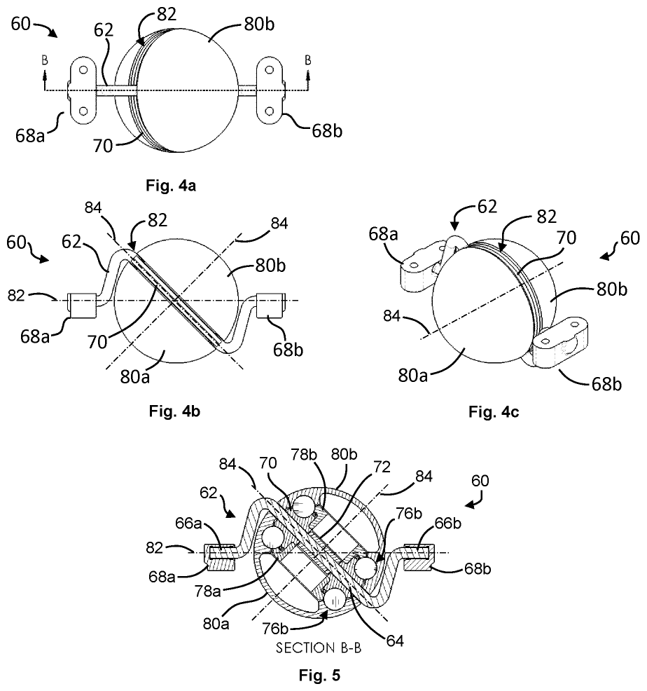

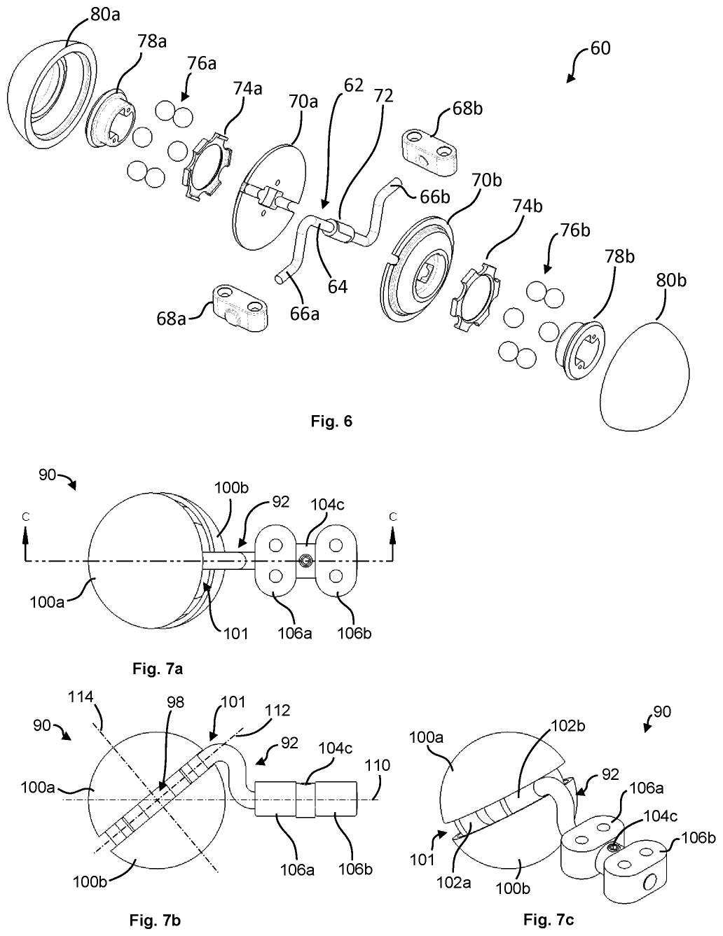

Turning now to FIGS. 4a to 6, a second embodiment of a wheel assembly 60 according to the present invention is illustrated. The wheel assembly 60 comprises a shaft 62, which in the illustrated embodiment consists of a central portion 64 and two end portions 66a,b. As can best be seen in the section view of FIG. 5 and the exploded view of FIG. 6, this angling of the shaft 62 results in the end portions 66a,b defining a first axis 82 while the central portion 64 defines a second axis 84. The end portions 66a,b are provided with bearings 68a,b for rotatable connection to the object (not shown). The shaft 62 is further provided with a thrust collar 72 fixed to the shaft 62.

The wheel assembly 60 further comprises two hub sections 70a,b which are affixed to each other so as to retain the shaft 62 therebetween in respective facial grooves and restrained axially by thrust collar 72 and retainers 74a,b disposed outside the hub sections 70a,b. The retainers 74a,b provide a receiving member for ball bearings 76a,b which are secured in place by bearing caps 78a,b. Hemispherical members 80a,b are rotatably connected to the hub sections 70a,b by means of ball bearings 76a,b rolling within integrated grooves, and are held to the hub 70 by bearing caps 78a,b and kept equi-spaced within the grooves by cages 74a,b. A gap 82 between the hemispheres 80a,b allow the shaft 62 to pass through.

As is the case with the first wheel assembly 31, the second wheel assembly 60 embodies three axes of rotation to enable the desired omni-directional movement. The shaft 62 rotates relative to the object being mobilized around a first axis 82, the hub sections 70a,b rotate relative to the shaft 62 around a second axis 84, and the hemispherical members 80a,b rotate relative to the hub sections 70a,b around a third axis 84.

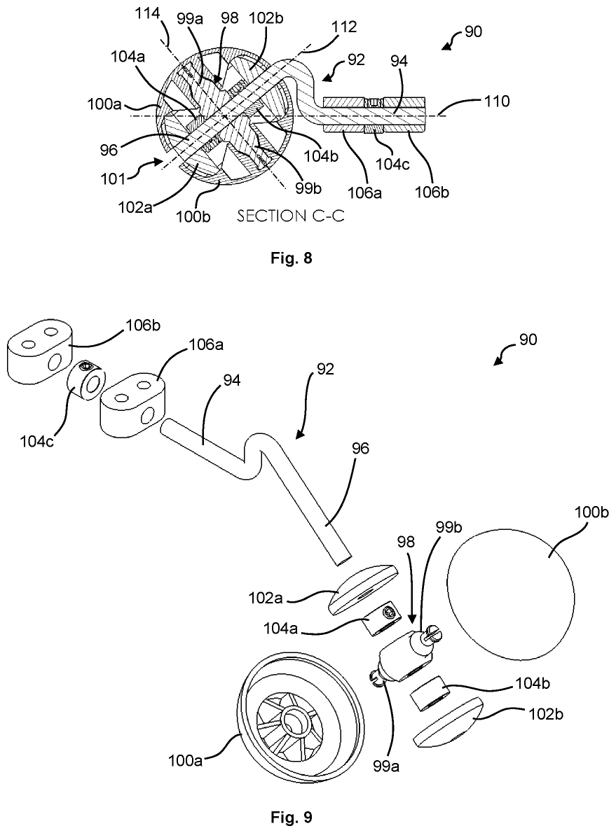

Turning now to FIGS. 7a to 9, a third embodiment of a wheel assembly 90 according to the present invention is illustrated. The wheel assembly 90 comprises a shaft 92, which in the illustrated embodiment consists of an angled portion 96 and an end portion 94. As can best be seen in the section view of FIG. 8 and the exploded view of FIG. 9, this angling of the shaft 92 results in the end portion 94 defining a first axis 110 while the angled portion 96 defines a second axis 112. The end portion 94 is provided with bearings 106a,b for rotatable connection to the object (not shown). The shaft 92 is further provided with a thrust collar 104c fixed to the shaft 92 for axial relative to the bearings 106a,b.

The wheel assembly 90 further comprises a hub which the shaft 92 passes through, and is restrained axially on the shaft 92 by thrust collars 104a,b. Hemispherical members 100a,b are rotatably connected to the hub 98 by means of spindles 99a,b. A gap 101 between the hemispheres 100a,b allow the shaft 92 to pass through. Wheels 102a,b are rotatably connected to the shaft 92, held captive between the hemispheres 100a,b, and bear against inner surfaces on the hemispheres 102a,b; they supplement the stability and load-bearing capability of the hub 98, ensuring the edges of the hemispheres 102a,b do not contact the shaft 92 during operation.

As is the case with the first wheel assembly 31, the third wheel assembly 90 embodies three axes of rotation to enable the desired omni-directional movement. The shaft 92 rotates relative to the object being mobilized around a first axis 110, the hub 98 rotates relative to the shaft 92 around a second axis 112, and the hemispherical members 100a,b rotate relative to the hub 98 around a third axis 114.

As will be clear to those skilled in the art, embodiments according to the present invention may present numerous advantages over the prior art. For example, there are potential advantages over conventional caster wheels in terms of increased stability, reduced space requirement for a given wheel diameter, and reduced necessary structural strength at the object's connection point(s) due to transmitted load passing through a fixed center point and the potential for torque-less connection to the object. While ball casters require a hard, slippery material and may be susceptible to contaminant accumulation, these are not issues for the present invention. Omni-wheels, Mecanum wheels, and the omni-ball all have small rolling elements to enable rolling in certain directions, which may be disadvantageous on more challenging terrain, whereas embodiments of the present invention employ the full outer diameter of hemispherical members for rolling in all directions, which is advantageous for moving over challenging terrain. For the prior art assembly where a spherical wheel is supported by omni-wheels, embodiments of the present invention can enable less complex assemblies and reduced the space requirement.

1. A wheel assembly comprising:
a shaft configured for rotatable connection to an object for rotation around a first axis, the first axis being non-vertical when the shaft is connected to the object;
a hub rotatably connected to the shaft for rotation around a second axis; and
two hemispherical members rotatably connected to the hub for rotation around a third axis;
the shaft comprising an angled portion to define the second axis and at least one non-angled portion to define the first axis; and
wherein the first axis and the second axis are at a non-normal angle to each other.

2. The wheel assembly of claim 1 wherein the object is a piece of furniture, an office chair, a shopping cart or a dolly.

3. The wheel assembly of claim 1 wherein the at least one non-angled portion is two non-angled portions separated by the angled portion.

4. The wheel assembly of claim 1 wherein the at least one non-angled portion comprises an end portion rotatably connected to at least one bearing, the at least one bearing configured for mounting on the object.

5. The wheel assembly of claim 4 wherein the end portion defines the first axis.

6. The wheel assembly of claim 4 wherein the at least one non-angled portion is two non-angled portions separated by the angled portion, each of the two non-angled portions comprising an end portion, the two end portions defining the first axis.

7. The wheel assembly of claim 1 wherein the hub is rotatably connected to the angled portion of the shaft.

8. The wheel assembly of claim 7 wherein the hub is rotatably connected to the angled portion of the shaft by at least one bearing.

9. The wheel assembly of claim 1 wherein the hemispherical members are rotatably connected to the hub by bearings to rotate around the third axis.

10. The wheel assembly of claim 1 wherein the hemispherical members are spaced apart to form a gap through which the angled portion of the shaft passes.

11. The wheel assembly of claim 1 further comprising a thrust collar fixedly mounted on the angled portion of the shaft for axially restraining the hub on the shaft.

12. The wheel assembly of claim 11 further comprising retainers, the thrust collar and the retainers axially restraining the hub on the shaft.

13. The wheel assembly of claim 12 wherein the retainers receive and retain ball bearings, the ball bearings secured in place by bearing caps, the ball bearings supporting rotation of the hemispherical members.

14. The wheel assembly of claim 1 wherein the hub comprises two hub sections affixed together and comprising inwardly disposed facial grooves, the facial grooves configured for receipt of the angled portion of the shaft, the hub sections thereby retaining the angled portion of the shaft within the facial grooves.

15. The wheel assembly of claim 1 wherein the non-angled portion of the shaft is provided with;
at least one bearing configured for rotatable connection to the object; and
a thrust collar;
the thrust collar fixed to the non-angled portion of the shaft to restrain axial movement of the shaft relative to the at least one bearing.

16. The wheel assembly of claim 1 wherein the hemispherical members are rotatably connected to the hub by spindles extending radially from the hub.

17. The wheel assembly of claim 1 further comprising wheels rotatably connected to the angled portion of the shaft and bearing against inner surfaces of the hemispherical members.

18. The wheel assembly of claim 1 wherein the two hemispherical members define a sphere having a centre, the first axis and the second axis and the third axis intersecting at the centre of the sphere.
